(19) United States
(12) Patent Application Publication
(10) Pub. No.: US 2007/0062106 A1
(43) Pub. Date: Mar. 22, 2007

(54) Landscape protection device

(76) Inventors: Paul R. Dunbar, Beverly Hills, MI (US); Mark R. Jones, West Bloomfield, MI (US); Terry R. Richards, Williamston, MI (US)

Correspondence Address: HARNESS, DICKEY & PIERCE, P.L.C., P.O. BOX 828, BLOOMFIELD HILLS, MI, 48303, US

(21) Appl. No.: 11/225,646

(22) Filed: Sep. 13, 2005

(51) Int. Cl. A01G 1/08

(52) U.S. Cl. 47/33

(57) ABSTRACT

A landscape protection device and method are described. The landscape protection device includes two or more U-shaped members with footing portions adapted to insert into a ground surface. Attached between the U-shaped members are crossbar members that support the U-shaped members forming a frame suitable for receiving a material covering. The U-shaped members and crossbar members are designed for interconnect ability and customized extension and creation of a frame for landscape protection. A method provides for interconnect ability of the U-shaped members and crossbar members creating a landscape protection device of sufficient length.

### FIELD OF THE INVENTION

The present invention relates to a device for shielding and protecting landscaping, more particularly a device for interconnected structural protection of landscaping.

### BACKGROUND

Protecting landscaping plants, particularly small decorative trees, shrubs, bushes, hedges, evergreens including arborvitae, is a challenge in geographical regions where the climate provides cool or hot weather. Traditionally, landscaping plants have been protected by an assembly of wooden stakes with burlap cloth attached. The stakes are driven into the ground by sledgehammer and the burlap is applied to the stake by nail or staple. There are many problems with this or similar forms of landscaping plant protection. Wooden stakes are difficult to position in the ground in an orderly manner and are prone to breakage and deterioration over time. Burlap, likewise, tends to sag and deteriorate quickly. As a result, wooden stakes and burlap tend to be unusable for more than one seasons and result in a less than desirable aesthetic appearance over time.

Other forms of plant enclosures are also unsuitable for application in a typical landscaping setting where hedging, for example, curves. Protection devices adapted for protecting a single plant or grouping of plants are not capable of interconnected protection of plant rows especially if the rows form curved lines.

Therefore, there is needed a landscaping protection device that provides an environmentally resistant sturdy structure that can be reused season after season. The landscaping protection device must allow for an ability to interconnect and an ability to traverse uneven terrain and curved landscaping. Further, it is desirable that such a structure be easily assembled and disassembled for further reuse. In addition, the device must be cost effective and provide a long term aesthetically pleasing appearance in addition to full coverage and protection of the landscaping plants.

### SUMMARY OF THE INVENTION

The present invention is directed to a landscape protection device and method that provides a solution to the aforementioned problems associated with other landscape protection systems. The landscape protection device comprises at least two generally U-shaped members each having two footing portions for insertion into a ground surface. It further comprises at least two crossbar members for connecting between each of the at least two U-shaped members for supporting the at least two U-shaped members and forming a frame. In addition, it comprises a covering material for covering the frame wherein the at least two U-shaped members and the at least two crossbar members are at least partially enclosed by a covering material.

Further, the at least two U-shaped members of the landscape protection device are interconnected with additional U-shaped members through attachment of additional crossbar members wherein said frame is extendable. Additional crossbar members may be curved and the footing portions of the U-shaped members may comprise a stake for insertion into the ground surface.

A method for protecting landscaping with the landscaping protection device comprises providing a plurality of generally U-shaped members having holes for fasteners and at least two footing portions for insertion into a ground surface. Further, providing a plurality of crossbar members for attaching horizontally to the U-shaped members where the crossbar members vary in length and angle to allow for customized assembly of the landscape protection device. Then, positioning one of the plurality of U-shaped members in proximity to the landscaping. Next, positioning another of the U-shaped members in proximity to the landscaping. Then selecting at least two horizontal members of appropriate length and angle from the plurality of horizontal members, and attaching the selected crossbar members between two of the U-shaped members. This last set of steps are repeated at least two times until a frame of the landscaping protection device is constructed and then a covering is attached to the frame of the landscaping protection device.

Thus, the invention advantageously provides for a cost effective efficient device and method for protecting landscaping. By providing for a frame that is easy to assemble and extend or modify to a desired length and angle while at the same time allowing for traversal of uneven grade, the invention provides an important alternative to existing systems and methods.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a perspective view of an embodiment of the landscape protection device of the invention in an exemplar landscape setting;

FIG. 2 shows a perspective cutaway view of two sections of the embodiment of the landscape protection device of FIG. 1;

FIG. 3A shows a crossbar member of the landscape protection device of FIG. 2;

FIG. 3B shows a second embodiment of the crossbar member of the landscape protection device with a fastener screw disposed in one end;

FIG. 3C shows a 90° curved embodiment of the crossbar member of the landscape protection device;

FIG. 3D shows a 150° curved embodiment of a crossbar member of the landscape protection device;

FIG. 3E shows a 135° curved embodiment of a crossbar member of the landscape protection device;

FIG. 3F shows a 112.5° curved embodiment of the crossbar member of the landscape protection device;

FIG. 4 shows a fastener connection in a cutaway fashion of the landscape protection device of FIG. 2; and

FIG. 5 shows an alternative fastener connection of the landscape protection device.

### DETAILED DESCRIPTION OF THE PREFERRED EMBODIMENTS

The following description of the preferred embodiment(s) is merely exemplary in nature and is in no way intended to limit the invention, its application, or uses.

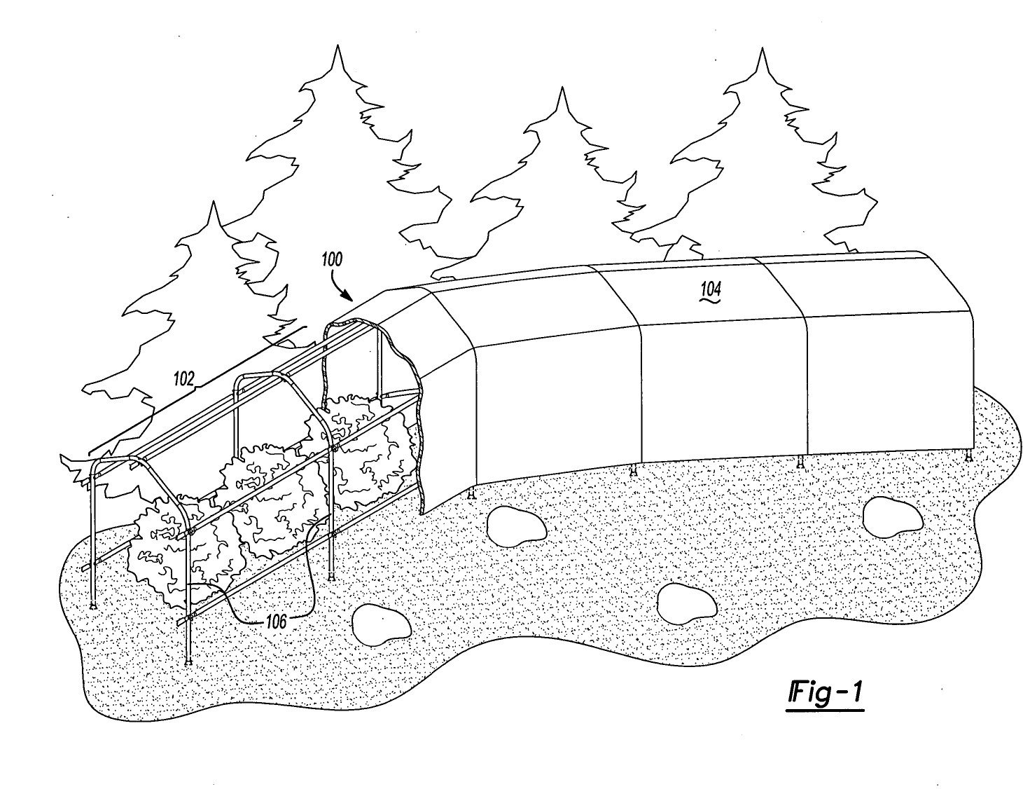

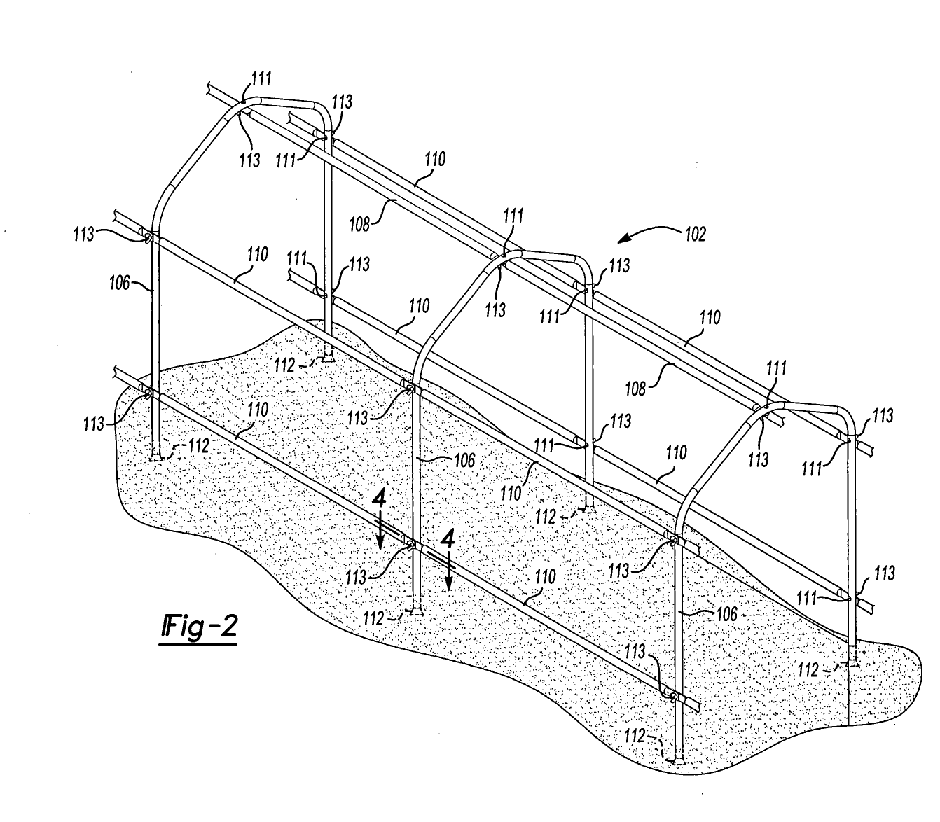

Referring to FIGS. 1 and 2, an embodiment of the landscape protection device 100 of the present invention is shown. The landscape protection device 100 features a frame 102 with an external material covering 104. The frame 102 features a plurality (two or more) of U-shaped members 106 with horizontal crossbar members 110 attached to the top and sides of the U-shaped members 106.

The U-shaped members 106 and crossbar members 110 are formed of a rigid tubular material preferably tubular galvanized steel. Alternatively, a ridged tubular plastic material may be used. The tubular galvanized steel is coated with a finish preferably a powder coating. Other coating options, for example, enamel paints, are appropriate to the extent that they resist corrosion. The external material covering 104 is made of a material suitable for the outside. Preferably the material is of a polymetric type.

The U-shaped members 106 feature a footing portion 112 for insertion into a ground surface. Footing portion 112 is formed by collapsing the tubing of the U-shaped members 106 to create a pointed end for easier insertion into the ground surface. Crossbar members 110 are fastened to U-shaped members 106 by screws 111 and wing nuts 113.

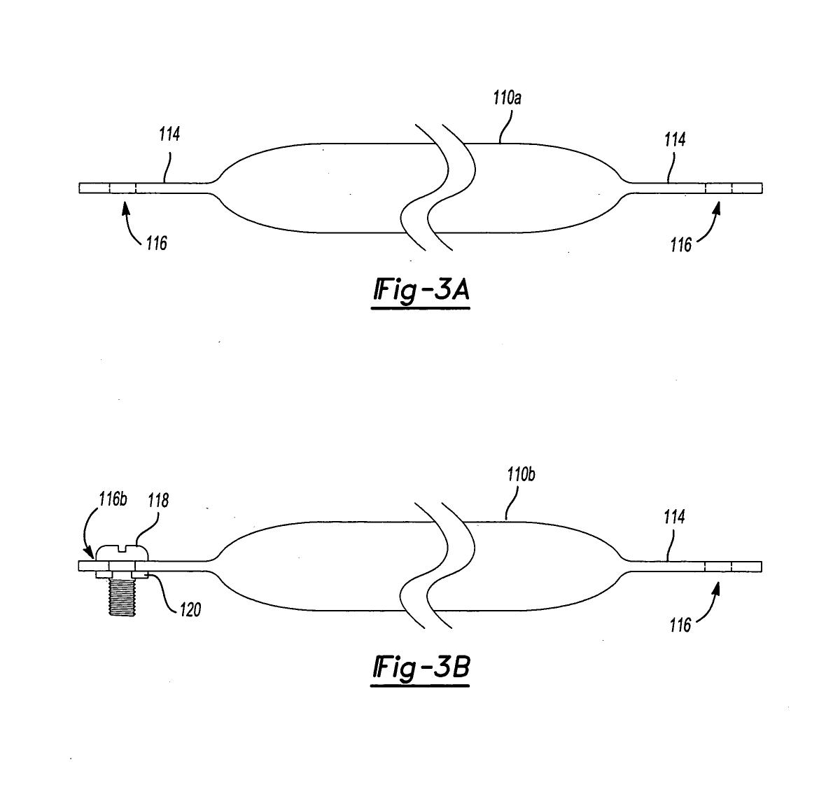

Referring to FIGS. 3A-3F, embodiments of the crossbar member 110 include the standard crossbar member 110a featuring a straight pipe section with tapered end portions 114. The tapered end portions 114 have fastener holes 116 therethrough for fastening to the U-shaped members 106 (see FIG. 2).

An alternative crossbar member 110b features an attached screw 118 at one end of a pipe section. The attached screw 118 is held in place by a retention pin 120 that allows the attached screw 118 to rotate freely within the retained fastener hole 116b of alternative crossbar member 110b. The other end of the alternative crossbar member 110b has a fastener hole 116 suitable for receiving the attached screw 118 of another of the alternative crossbar members 110b. This embodiment advantageously allows for a chain connection of two alternative crossbar members 110b to one of the U-shaped members 106 at any one connection location on one of the U-shaped members 106. Thus, a desired number of U-shaped members 106 and alternative crossbar members 110b are easily attached together without the necessity of loading screws in holes for fastening to the U-shaped members 106.

Additional embodiments of the crossbar member 110 feature curvature of the crossbar member 110 to allow for construction of the frame 102 in a landscape environment having a curved or uneven arrangement of plantings.

Crossbar members of various angles include a 90° crossbar member 110c, a 150° crossbar member 110d, a 135° crossbar member 110e and a 112.5° crossbar member 110f. Crossbar members 110 are also of varying lengths to allow for connection to both sides of the frame 102 in a non-linear assembly of the frame 102 (see FIG. 1). In addition, a crossbar member 110 on top of the U-shaped members 106 that is curved must have the curve coincide with the flattened end portions 114 for proper attachment to the U-shaped member 106.

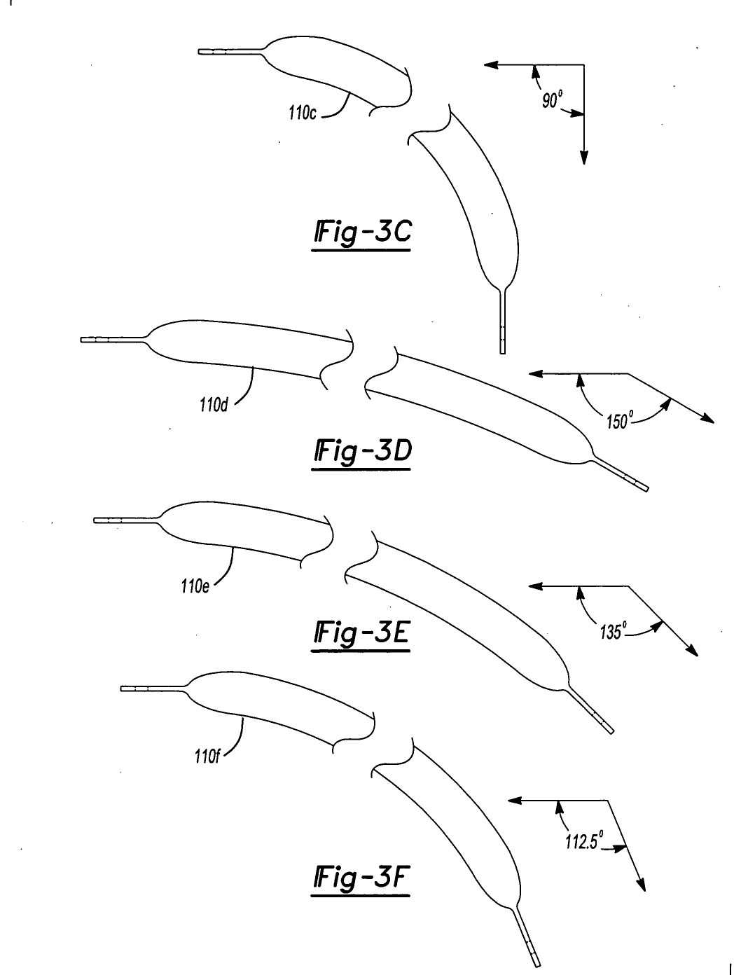

Referring to FIG. 4, a first crossbar member 110′ and a second crossbar member 110″ are attached to a U-shaped member 106 by a threaded screw 111. The threaded screw 111 traverses a hole 117 from one side of the U-shaped member 106 and passes through a first fastener hole 116′ and a second fastener hole 116″ in the first crossbar member 110′ and second crossbar member 110″ respectively. A wing nut 113 is rotated onto the screw 111.

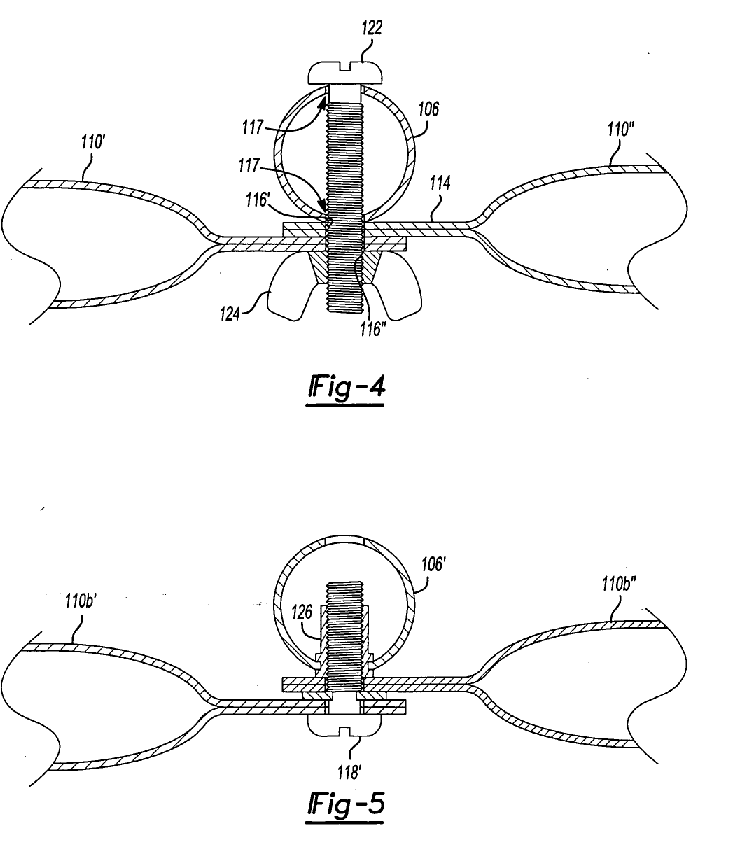

Referring to FIG. 5, alternative crossbar members 110b′ and 110b″ are attached to a fastener retaining U-shaped member 106′ by a screw 111′. The screw 111′ attaches both the first alternative crossbar member 110b′ and the second alternative crossbar member 110b″ to the fastener retaining U-shaped member 106′. Disposed in the fastening retaining U-shaped member 106′ is a rivet nut 126 for receiving the screw 111′ through the first alternative crossbar member 110b′ and second alternative crossbar member 110′.

In usage, at least two U-shaped members 106 are positioned in proximity to landscaping to be protected. Crossbar members 110 are attached to the at least two U-shaped members 106 to form a frame 102. The crossbar members are attached to the frame 102 through a screw and nut application either using a screw 111 and wing nut 113 as illustrated in FIGS. 1, 2 and 4 or as an attached screw 118′ to one of the alternative crossbar members 110b′ as illustrated in FIG. 5. Selection of either straight or various angled crossbar members 110 as illustrated in FIGS. 3A-3F allows for interconnecting and extending the frame 102 of the landscape protection device 100 to a desired length and angled structure. After having constructed the frame 102, material covering 104 is applied over the frame 102 to protect the landscaping beneath.

Thus, a relatively inexpensive yet durable solution is provided for landscape protection. This landscape protection device 100 further offers the advantage of an ability to interconnect allowing for virtually unlimited options for combining and extending the length and angle of the structure to the application desired. Once in place, the landscape protection device is solid and secure and resilient to environmental conditions including snow, wind and rain. Further, the landscape protection device by advantageously offering easy disconnect is readily reusable season after season.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A landscape protection device comprising:
at least two generally U-shaped members each having footing portions for contacting a ground surface;
at least two crossbar members for connecting between each of the at least two U-shaped members for supporting the at least two U-shaped members and forming a frame; and
a covering material for covering the frame wherein the at least two U-shaped members and the at least two crossbar members are at least partially enclosed by the covering material.

2. The landscape protection device of claim 1 wherein said at least two U-shaped members are inter-connectable with additional U-shaped members through attachment of additional crossbar members, wherein said frame is extendable.

3. The landscape protection device of claim 2 wherein the additional crossbar members are curved.

4. The landscape protection device of claim 1 wherein the footing portions comprise a stake for inserting into the ground surface.

5. The landscape protection device of claim 1 wherein the U-shaped members and the crossbar members comprise a tubular material.

6. The landscape protection device of claim 5 wherein the tubular material is a tubular metal.

7. The landscape protection device of claim 6 wherein the tubular metal is galvanized.

8. The landscape protection device of claim 5 wherein the tubular material is a tubular plastic.

9. The landscape protection device of claim 1 wherein the covering material comprises a polymeric material.

10. The landscape protection device of claim 1 wherein the covering material is pre-formed to fit over at least three sides of the frame.

11. The landscape protection device of claim 1 wherein the U-shaped members comprise a plurality of fasteners with internal threads disposed within the U-shaped members; and
wherein the crossbar members comprise a hole on a first end for attachment to a U-shaped member and a screw rotatably disposed in a hole in a second end of the crossbar members for screwing into one of the fasteners in one of the U-shaped members.

12. A landscaping plant protection device comprising:
at least two vertical members each having two footing portions for contacting a ground; and
at least two horizontal members for attaching horizontally between two of the vertical members.

13. The device of claim 12 wherein the vertical members are formed of a rigid tubular material.

14. The device of claim 12 wherein the horizontal members are formed of a rigid tubular material.

15. The device of claim 12 wherein a fastener screw is rotatably disposed in at least one end of the horizontal members.

16. The device of claim 12 wherein a fastener nut is disposed in the vertical members for attaching the horizontal members to the vertical members.

17. The device of claim 12 wherein the footing portions comprise a stake for inserting into a ground surface.

18. The device of claim 12 further comprising a covering material for covering a frame formed by connection of the horizontal members to the vertical members.

19. A method for protecting landscaping with a landscaping protection device comprising:
providing a plurality of generally U-shaped members having holes for fasteners and at least two footing portions for insertion into a ground surface;
providing a plurality of horizontal members for attaching horizontally to the U-shaped members wherein the horizontal members vary in length and angle to allow for customized assembly of the landscaping protection device;
positioning one of the plurality of U-shaped members in proximity to landscaping;
a. positioning another of the u-shaped members in proximity to the landscaping;
b. selecting at least two horizontal members of appropriate length and angle from the plurality of horizontal members;
c. attaching the selected horizontal members between two of the U-shaped members;
repeating step a. to c. at least two times until a suitable frame of the landscaping protection device is constructed; and
attaching a covering to the frame of the landscaping protection device.

20. The method for protecting landscaping with a landscaping protection device of claim 18 further comprising:
pushing footing portions of the U-shaped members into a ground surface.
